(19) United States
(12) Patent Application Publication
(10) Pub. No.: US 2017/0350556 A1
(43) Pub. Date: Dec. 7, 2017

(54) RESISTANCE WELDING PINCH PROTECTION SYSTEM

(71) Applicant: TECHNO-CONTROL CYBERNETIC INC., TERREBONNE (CA)

(72) Inventor: JEAN-PIERRE DERDEYN, TERREBONNE (CA)

(21) Appl. No.: 15/609,533

(22) Filed: May 31, 2017

Related U.S. Application Data
(60) Provisional application No. 62/344,027, filed on Jun. 1, 2016.

(51) Int. Cl. F16P 3/00; B23K 11/11; B23K 37/00; G01B 21/16

(52) U.S. Cl. CPC F16P 3/005; G01B 21/16; B23K 11/115; B23K 37/006

(57) ABSTRACT

A resistance welding pinch protection system for use with a resistance welder, comprising a sensor array adapted to be secured around the base of a positive electrode of the resistance welder, the sensor array including a plurality of proximity sensors positioned along a perimeter of the sensor array, the plurality of proximity sensors defining an electrode operation field around the positive electrode, an input/output interface to be operatively connected to the resistance welder, and at least one processor in communication with the plurality of proximity sensors and the input/output interface, wherein in use, during the lowering of the positive electrode, the at least one processor interrupts the control signal to the resistance welding controller in order to stop the welding sequence, raising the positive electrode in response to the detection of an obstacle within the electrode operation field.

### CROSS-REFERENCE TO RELATED APPLICATIONS

This application claims benefit of U.S. provisional application Ser. No. 62/344,027, filed on Jun. 1, 2016. All documents above are incorporated herein in their entirety by reference.

### TECHNICAL FIELD

The present disclosure relates to a resistance welding pinch protection system.

### BACKGROUND

Common resistance welding pinch protection systems rely on physical touch sensing in order to detect obstacles. Such systems are differentiated pressure systems that use low pressure during the lowering of the electrode and detection, and high pressure during welding. This has for effect a reduction in the lowering speed of the electrode.

Accordingly, there is a need for resistance welding pinch protection system that alleviates those disadvantages.

### SUMMARY

According to the present invention, there is provided a resistance welding pinch protection system for use with a resistance welder, comprising a sensor array adapted to be secured around the body of a positive electrode of the resistance welder, the sensor array including a plurality of proximity sensors positioned along a perimeter of the sensor array, the plurality of proximity sensors defining an electrode operation field around the positive electrode, an input/output interface to be operatively connected to the resistance welder, and at least one processor in communication with the plurality of proximity sensors and the input/output interface, wherein in use, during the lowering of the positive electrode, the at least one processor interrupts the control signal to the resistance welding controller in order to stop the welding sequence, raising the positive electrode in response to the detection of an obstacle within the electrode operation field.

In an alternative embodiment, the resistance welding pinch protection system further comprises a controller and a positive and a negative probe to be operatively connected to the positive electrode and a negative electrode, respectively, of the resistance welder, the positive and negative probes being in communication with the at least one processor, wherein in use, if no obstacle is detected within the electrode operation field during the lowering of the upper electrode, the at least one processor allows the welding sequence by the controller to apply a current between the positive and negative electrodes, electrical conductivity between the positive and negative electrodes confirming a distance reference.

The main advantage of the disclosed resistance welding pinch protection system is its compatibility with any pneumatic resistance welder, regardless of the controller or the pneumatic cylinder, servo-pneumatic or servo motor it uses.

Another advantage is that the resistance welding pinch protection system is external to the resistance welder, the detection of obstacles is performed using proximity sensors that do not affect the lowering speed of the electrode since it does not rely on physical touch sensing, which requires differentiated pressure mechanisms (i.e. low pressure for lowering of the electrode and detection, and high pressure for welding).

The foregoing features and advantages of this system will become more readily apparent from the following detailed description.

### BRIEF DESCRIPTION OF THE FIGURES

Embodiments of the disclosure will be described by way of examples only with reference to the accompanying drawing, in which:

FIG. 1 is an elevation perspective view of a spot welder equipped with a resistance welding pinch protection system in accordance with an illustrative embodiment of the present disclosure;

FIG. 2 is a close-up view of the resistance welding pinch protection system shown in FIG. 1; and

FIG. 3 is a schematic diagram of the resistance welding pinch protection system in accordance with the illustrative embodiment of the present disclosure.

Similar references used in different Figures denote similar components.

### DETAILED DESCRIPTION

Generally stated, the non-limitative illustrative embodiments of the present disclosure provide a resistance welding pinch protection system that uses, during the welding process, detection of obstacles in order to proceed with the welding operation. The resistance welding pinch protection system operates transparently with regard to the operations of the welding equipment and does not affect the speed or the lowering pressure of the electrodes. The system is designed to interrupt the welding sequence if an obstacle is detected within the welding field.

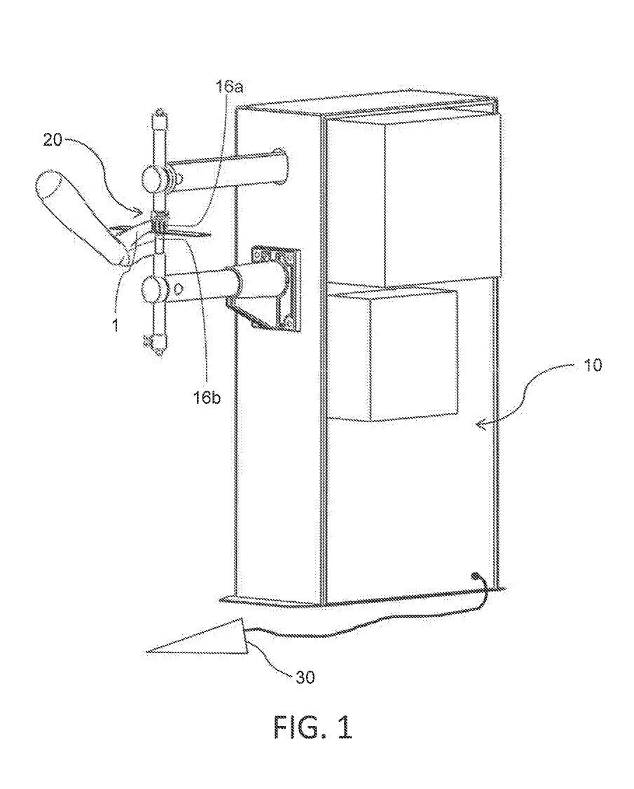

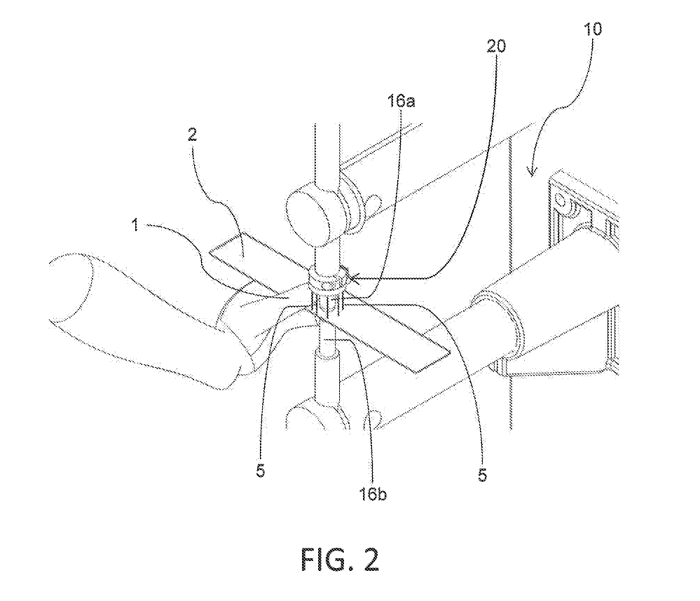

Referring to FIGS. 1 and 2, there is shown a resistance welder 10 (here a spot welder) equipped with resistance welding pinch protection system 20, which is secured around the base of an upper positive electrode 16a, in accordance with an illustrative embodiment of the present disclosure.

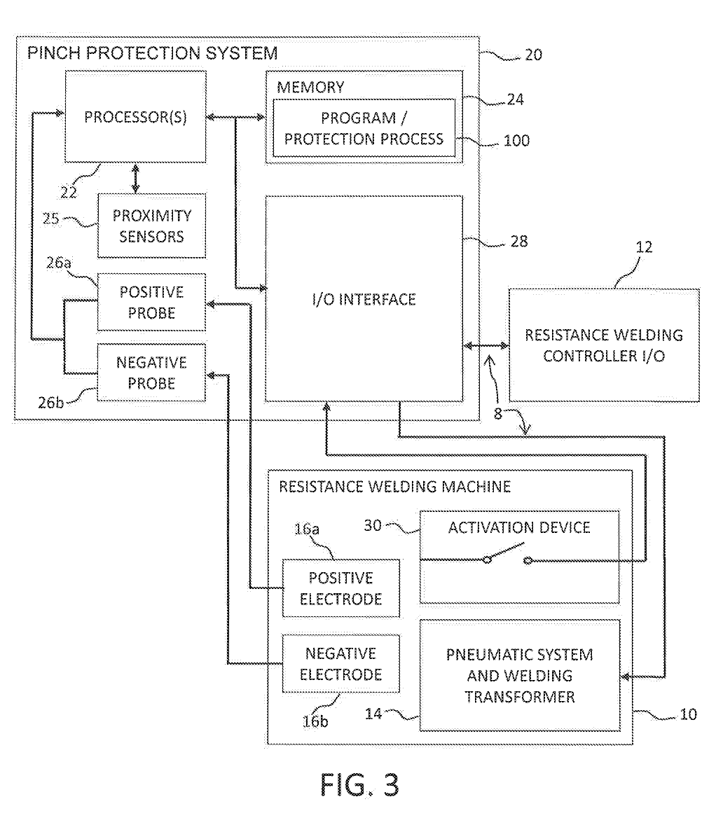

Referring now to FIG. 3, the resistance welding pinch protection system 20 generally includes one or more processors 22 with associated memory 24 storing the executable instructions to perform the protection process 100, a plurality of proximity sensors 25, positive 26a and negative 26b probes and an input/output (I/O) interface 28 for communication with the resistance welder 10 and resistance welding controller 12 through a communication link 8, which may be wired or wireless.

The resistance welding pinch protection system 20 is connected between the resistance welding controller 12 and the pneumatic system and welding transformer 14 of the resistance welder 10, and acts as the priority management system. The positive 26a and negative 26b probes are connected to the positive 16a and a negative 16b electrode outputs, respectively, of the resistance welder 10. When the electrodes 16a, 16b touch each other or a conductive material, the resistance welding pinch protection system 20 detects an electric potential difference, indicating that there was an electrical contact, thus confirming a distance reference.

When the resistance welder 10 is powered up, the resistance welding pinch protection system 20 is activated and goes into the protection mode. While in the protection mode the resistance welder 10 cannot be activated.

In order to execute a welding operation, an operator places the workpiece 2 to be welded between the electrodes 16a, 16b, then initiates a reset of the resistance welding pinch protection system 20 using the interface 28, and then activates the resistance welder 10. The processor 22 intercepts the welding activation signal from the activation device (i.e. pedal or other means of activation) 30 and initiates a reference for the workpiece 2 to be welded. The reference 30 consists in taking a reading from its inputs (i.e. proximity sensors 25, positive 26a and negative 26b probes), which define the protection field reference.

Referring now to FIGS. 2 and 3, the processor 22 then permits signals to the pneumatic system and resistance welding controller 12, lowering the positive electrode 16a towards the workpiece 2. While the positive electrode 16a is being lowered, the proximity sensors 25 emit a plurality of rays 5 encircling the positive electrode 16a and defining an electrode operation field. An obstacle (e.g. finger 1 of the operator) within the electrode operation field is detected when one or more of the rays 5 is reflected back to a corresponding proximity sensor 25, at which time the processor 22 immediately interrupts the control signal to the pneumatic system and welding controller 12 and raises the positive electrode 16a.

If no obstacle is detected, the pressure is applied and the positive electrode 16a makes contact with the conductive workpiece 2, and then a reading from the positive 26a and negative 26b probes is taken to confirm the distance reference. For highly resistive material (i.e. prepainted material) the distance reference will be confirmed when the welding, through the applied current, will allow the electrical contact to happen.

Although the present disclosure has been described with a certain degree of particularity and by way of illustrative embodiments and examples thereof, it is to be understood that the present disclosure is not limited to the features of the embodiments described and illustrated herein, but includes all variations and modifications within the scope of the disclosure as hereinafter claimed.

What is claimed is:

1. A resistance welding pinch protection system (20) for use with a resistance welder (10), comprising:
a sensor array to be secured around the body of a positive electrode (16a) of the resistance welder (10), the sensor array including:
a plurality of proximity sensors (25) positioned along a perimeter of the sensor array, the plurality of proximity sensors (25) defining an electrode operation field around the positive electrode (16a);
an input/output interface (28) to be operatively connected to the resistance welder (10); and
at least one processor (22) in communication with the plurality of proximity sensors (25) and the input/output interface (28);
wherein in use, during the lowering of the positive electrode (16a), the at least one processor (22) interrupts the control signal to the resistance welding controller (12) in order to stop the welding sequence, raising the positive electrode (16a) in response to the detection of an obstacle within the electrode operation field.

2. A resistance welding pinch protection system (20) in accordance with claim 1, further comprising:
a controller (12); and
a positive (26a) and a negative (26b) probe to be operatively connected to the positive (16a) and a negative (16b) electrode, respectively, of the resistance welder (10), the positive (16a) and negative (16b) probes being in communication with the at least one processor (22);
wherein in use, if no obstacle is detected within the electrode operation field during the lowering of the positive electrode (16a), the at least one processor (22) allows the welding sequence by the controller (12) to apply a current between the positive (16a) and negative electrodes (16b), electrical conductivity between the positive (16a) and negative electrodes (16b) confirming a distance reference.
